(19) United States
(12) Patent Application Publication
(10) Pub. No.: US 2009/0240433 A1
(43) Pub. Date: Sep. 24, 2009

(54) System for Determining Risk of Loss to Coastal Wetlands

(75) Inventor: James T. Morris, Columbia, SC (US)

Correspondence Address: DORITY & MANNING, P.A., POST OFFICE BOX 1449, GREENVILLE, SC, 29602-1449, US

(73) Assignee: UNIVERSITY OF SOUTH CAROLINA, Columbia, SC (US)

(21) Appl. No.: 12/406,232

(22) Filed: Mar. 18, 2009

Related U.S. Application Data
(60) Provisional application No. 61/037,422, filed on Mar. 18, 2008.

(51) Int. Cl. G06F 19/00; G06F 17/18

(52) U.S. Cl. 702/2; 702/179

(57) ABSTRACT

In accordance with certain embodiments of the present disclosure, a system for determining risk of loss to a wetland habitat is provided. The system comprises a computer, the computer configured to receive light detection and ranging data about a wetland habitat elevation and calculate the frequency distribution of the wetland habitat elevation based on the light detection and ranging data. The computer is further configured to calculate a skewness statistic based on the frequency distribution of the wetland habitat elevation, the skewness statistic being negative, zero, or positive. The computer is configured to calculate risk of loss to the wetland habitat by utilizing the skewness statistic.

### CROSS-REFERENCE TO RELATED APPLICATION

The present application is based on and claims priority to U.S. Provisional Application Ser. No. 61/037,422 having a filing date of Mar. 18, 2008, which is incorporated by reference herein.

### GOVERNMENT SUPPORT CLAUSE

The present invention was developed with funding from the Environmental Protection Agency. Therefore, the government retains certain rights in this invention.

### BACKGROUND

The vertical elevation of the soil surface of coastal wetlands relative to the tidal frame is spatially and temporally variable, and is an important determinant of the productivity and stability of coastal wetlands and their resiliency to storms and rising sea levels. Conventionally, resiliency is quantified by computing the frequency distribution of marsh elevations. The frequency distributions of coastal wetland elevations fall within three distinct groups: 1) skewed against the lower vertical limit of the vegetation in the habitat, which is characteristic of a habitat with little or no resiliency; 2) skewed against the upper vertical limit of the vegetation in the habitat, signifying greatest resiliency of the habitat; or 3) normally distributed in the middle of the vegetation range, which indicates a system with moderate resilience, possibly in transition. The frequency distribution of the coastal wetland habitat can be diagnostic of the vulnerability of the coastal wetland habitat to storms and sea-level rise.

However, conventional methods require knowledge about the vertical limits of a wetland to assess the risk of wetland loss. A need exists for a method of determining risk of loss to coastal wetlands that does not require a priori knowledge of the vertical limits of such wetlands. A system implementing such a method would be particularly beneficial.

### SUMMARY

In accordance with certain embodiments of the present disclosure, a system for determining risk of loss to a wetland habitat is provided. The system comprises a computer, the computer configured to receive light detection and ranging data about a wetland habitat elevation and calculate the frequency distribution of the wetland habitat elevation based on the light detection and ranging data. The computer is further configured to calculate a skewness statistic based on the frequency distribution of the wetland habitat elevation, the skewness statistic being negative, zero, or positive. The computer is configured to calculate risk of loss to the wetland habitat by utilizing the skewness statistic.

In certain embodiments, the skewness statistic is calculated using the following formula:

$$skewness = \frac{{\sum }_{i - 1}^{N} {( {Y}_{i} - \overline{Y} )}^{3}}{( N - 1 ) {s}^{3}}$$

where N is equal to the number of samples of the wetland habitat elevation, Yᵢ are the values of the set of N elevations, Y̅ is the mean of all elevations, and s is the standard deviation, the skewness statistic being negative, zero, or positive.

In still other embodiments of the present disclosure, a method for determining risk of loss to a wetland habitat is provided.

### BRIEF DESCRIPTION OF THE DRAWINGS

A full and enabling disclosure, including the best mode thereof, directed to one of ordinary skill in the art, is set forth more particularly in the remainder of the specification, which makes reference to the appended figure in which:

FIG. 1 illustrates the effect of relative elevation on standing biomass density of S. alterniflora from the response obtained after a season of growth in experimental planters in accordance with the present disclosure;

FIG. 2 illustrates the measured effect of relative elevation on standing biomass density of S. alterniflora harvested from experimental planters as shown in FIG. 1 after a season of growth in accordance with the present disclosure;

FIG. 3 illustrates a range of possible elevations of the marsh platform relative to the vertical range of the vegetation in accordance with the present disclosure;

FIG. 4 illustrates frequency distributions of the surface elevations of hypothetical marsh habitats in accordance with the present disclosure;

FIG. 5 illustrates the effect of interannual variation in mean sea level and spatial variation in marsh elevation on the relationship of observed productivity of salt marsh macrophytes measured annually since 1984 and the depth below mean high tide of marsh sites in South Carolina in accordance with the present disclosure; and

FIG. 6 illustrates equilibrium combinations of biomass density (in panel A) and equilibrium depth D below mean high water (panel B) as functions of the rate of relative sea-level rise and computed from Equation 4 with q=0.0018 and k=1.5×10⁻⁵ in accordance with the present disclosure.

### DETAILED DESCRIPTION

Reference now will be made in detail to various embodiments of the disclosure, one or more examples of which are set forth below. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment, can be used on another embodiment to yield a still further embodiment. Thus, it is intended that the present disclosure covers such modifications and variations as come within the scope of the appended claims and their equivalents.

The systems and methods discussed herein can be implemented using servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes can be implemented using a single server or multiple servers working in combination. Databases and applications can be implemented on a single system or distributed across multiple systems. Distributed components can operate sequentially or in parallel.

When data is obtained or accessed between a first and second computer system or component thereof, the actual data can travel between the systems directly or indirectly. For example, if a first computer accesses a file or data from a second computer, the access can involve one or more intermediary computers, proxies, and the like. The actual file or data can move between the computers, or one computer can provide a pointer or metafile that the second computer uses to access the actual data from a computer other than the first computer, for instance.

The various computer systems that can be utilized with the present disclosure are not limited to any particular hardware architecture or configuration. Embodiments of the methods and systems set forth herein can be implemented by one or more general-purpose or customized computing devices adapted in any suitable manner to provide desired functionality. The device(s) can be adapted to provide additional functionality complementary or unrelated to the present subject matter, as well. For instance, one or more computing devices can be adapted to provide desired functionality by accessing software instructions rendered in a computer-readable form. When software is used, any suitable programming, scripting, or other type of language or combinations of languages can be used to implement the teachings contained herein. However, software need not be used exclusively, or at all. For example, some embodiments of the methods and systems set forth herein can also be implemented by hard-wired logic or other circuitry, including, but not limited to application-specific circuits. Of course, combinations of computer-executed software and hard-wired logic or other circuitry can be suitable, as well.

Embodiments of the methods disclosed herein can be executed by one or more suitable computing devices. Such system(s) can comprise one or more computing devices adapted to perform one or more embodiments of the methods disclosed herein. As noted above, such devices can access one or more computer-readable media that embody computer-readable instructions which, when executed by at least one computer, cause the at least one computer to implement one or more embodiments of the methods of the present subject matter. Additionally or alternatively, the computing device(s) can comprise circuitry that renders the device(s) operative to implement one or more of the methods of the present subject matter.

Any suitable computer-readable medium or media can be used to implement or practice the presently-disclosed subject matter, including, but not limited to, diskettes, drives, and other magnetic-based storage media, optical storage media, including disks (including CD-ROMS, DVD-ROMS, and variants thereof), flash, RAM, ROM, and other memory devices, and the like.

The present disclosure also can also utilize a relay of communicated data over one or more communications networks. It should be appreciated that network communications can comprise sending and/or receiving information over one or more networks of various forms. For example, a network can comprise a dial-in network, a local area network (LAN), wide area network (WAN), public switched telephone network (PSTN), the Internet, intranet or other type(s) of networks. A network can comprise any number and/or combination of hard-wired, wireless, or other communication links.

The present disclosure is generally directed to systems and methods for determining risk of loss to coastal wetlands. Risk of loss can refer to the risk of losing coastal wetlands to submergence (habitat loss) due to sea-level rise and erosion. The systems and methods described herein are based on an analysis and statistical treatment of Light Detection and Ranging (LIDAR) data. The vertical elevation of a wetland relative to the tidal frame is an important variable that determines the productivity of a wetland and its vulnerability to storms and rising sea level. LIDAR data provides information on the relative and absolute elevations of landscapes, but in the absence of knowledge about the vertical limits of a wetland, it is not possible to assess the risk of wetland loss. The present disclosure describes systems and methods of analyzing data to calculate a risk of loss estimate, without a priori knowledge of the vertical limits of a wetland or of its relative elevation. The calculated risk of loss statistic can be mapped, and its spatial distribution can reveal areas that are vulnerable to sea-level rise and erosion. Risk of loss can enhance understanding of the vulnerability of coastal wetland habitats to sea-level rise and the future change in marsh distribution.

In this regard, background information regarding the vertical limits within the tidal frame of salt marsh vegetation is now provided. In particular, the salt marsh grass S. alterniflora is well suited for a description of vertical limits of vegetation because it has been widely studied. However, it should be understood that the systems and methods of the present disclosure can be utilized in connection with any wetland area, irrespective of the presence or absence of S. alterniflora.

The standing biomass density of S. alterniflora is variable and changes with a number of environmental variables including the relative elevation of the marsh platform. Intertidal species are limited in their distribution by upper and lower limits of relative elevation, and these limits will vary considerably among different estuaries as a function of tidal range. For S. alterniflora, the lower limit is likely set by hypoxia resulting from tidal flooding, while the upper elevation is dictated by salt stress, desiccation, and competitive pressure from other species. The dominant representatives from different plant communities along a topographic gradient will have different biomass distributions that may or may not overlap, and interspecific competition or facultative interactions may modify the shapes of the curves where overlap occurs.

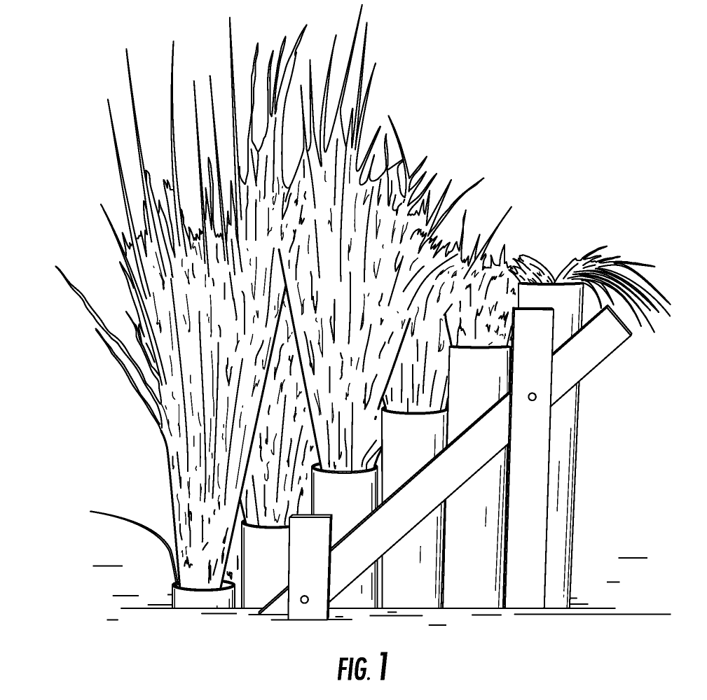

Theoretically, the vertical distribution of biomass density can be approximated by a parabola with an optimum depth that is bounded by upper and lower limits: Bₛ=aD+bD²+c. This curve can be viewed as dimensions of a species' fundamental (in the absence of competitors) or realized (in the presence of competitors) niche. The coefficients a, b, and c determine the upper, lower and optimal depth limits, and magnitude of Bₛ for a given depth (D) below mean high water. The values of the coefficients differ regionally as a function of tidal range or climate. The coefficients can be determined empirically by examining the height-biomass relationship of existing stands of vegetation within an estuary, or it can be determined experimentally as shown in FIG. 1.

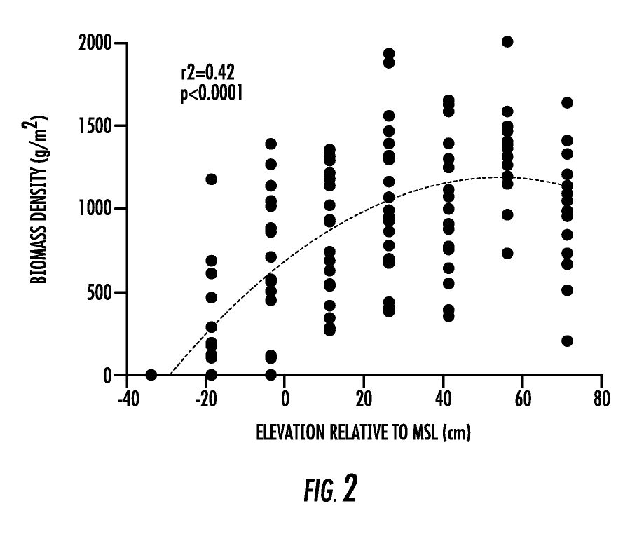

Referring to FIG. 1 and FIG. 2, the effect of relative elevation on standing biomass density of S. alterniflora is illustrated from the response obtained after a season of growth in experimental planters. The planters are filled to the tops with sediment. The results demonstrate that there exists an optimum elevation for S. alterniflora, and that at elevations greater than the optimum the above-ground biomass decreases as elevation increases while at elevations below the optimum, above-ground biomass decreases as elevation decreases.

It has been shown that the marsh platform will equilibrate at a relative elevation within the tidal frame, depending on the rate of sea-level rise (SLR). At a low rate of SLR, the marsh will equilibrate at a high elevation approaching mean high water (MHW), while at a rapid rate of SLR the marsh will equilibrate lower in the tidal frame. A stable marsh will exist in equilibrium with mean sea level only if the equilibrium elevation is within the vertical range of the vegetation. Furthermore, the elevation must be greater than the optimum elevation for marsh vegetation.

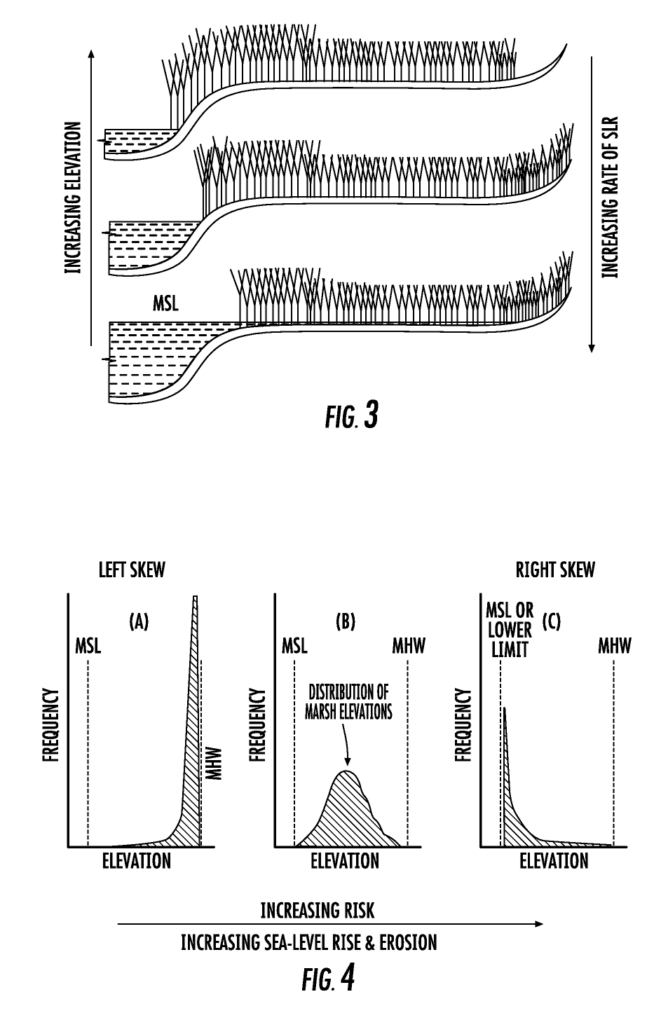

Referring to FIG. 3, the position of the marsh platform relative to the vertical range of the vegetation will result in one of three basic distributions. At a slow rate of SLR, the majority of the marsh surface will be positioned at the upper limit of the vegetation (top portion of FIG. 3), tailing off toward lower elevations at the margins of tidal creeks, while at fast SLR, the majority of the marsh platform will be positioned at the lower limit (bottom portion of FIG. 3), tailing off at higher elevations around the land margin. An intermediate position will have tails at both the lower and higher elevations (middle portion of FIG. 3).

Such distributions can be quantified and mapped by analyzing LIDAR data as would be understood by one of ordinary skill in the art. LIDAR data provides information on the relative and absolute elevations of landscapes. However, as discussed herein, in the absence of knowledge about the vertical limits of the vegetation, it has not been possible to assess the risk of wetland loss based solely on the elevations.

In accordance with the present disclosure, the vulnerability of a marsh to SLR can be assessed without a priori knowledge of the marsh's vertical limits by computing the skewness of the frequency distribution of wetland habitat elevation. In this regard, skewness is an asymmetrical frequency distribution in which the values are concentrated on one side of the mode with a long tail. If the tail is to the right or positive end of the scale, the distribution is said to be positively skewed. If the distribution trails off to the left or negative side of the scale, it is said to be negatively skewed.

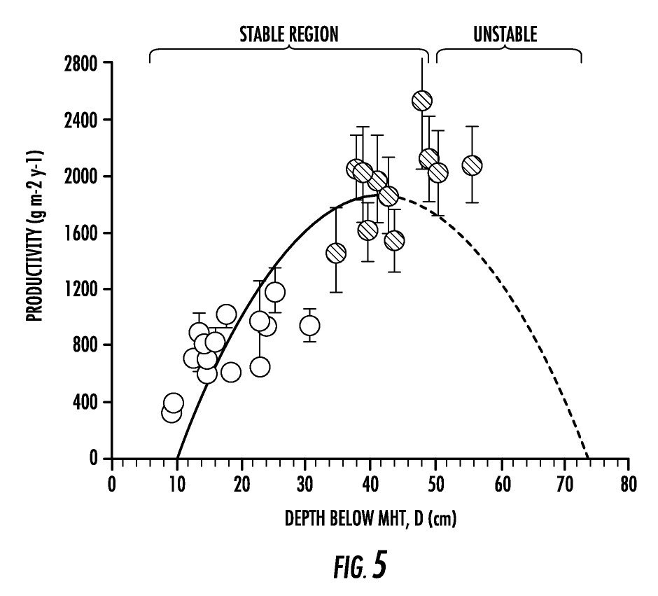

Referring to FIG. 3 and FIG. 4, if the habitat is situated at the highest elevation (top portion of FIG. 3), then the frequency distribution of surface elevations will be left-skewed (left portion of FIG. 4), i.e. the distribution will be truncated at the upper extreme elevation. Conversely, if the habitat is located near the lowest possible elevation (bottom portion of FIG. 3), then the frequency distribution will be right skewed and truncated at the lower limit (right portion of FIG. 4). Again, it is not necessary to know a priori what these absolute limits are, because they will be revealed by analysis of the frequency distributions. A marsh that is situated in the middle of its range will have a normal distribution (middle portion of FIG. 4). In terms of risk, a wetland with a negative skew will have the lowest risk of loss, while a wetland with a positive skew will have the greatest risk of loss. Absolute risk is directly proportional to skewness. A proof of this concept as it relates to the present disclosure follows.

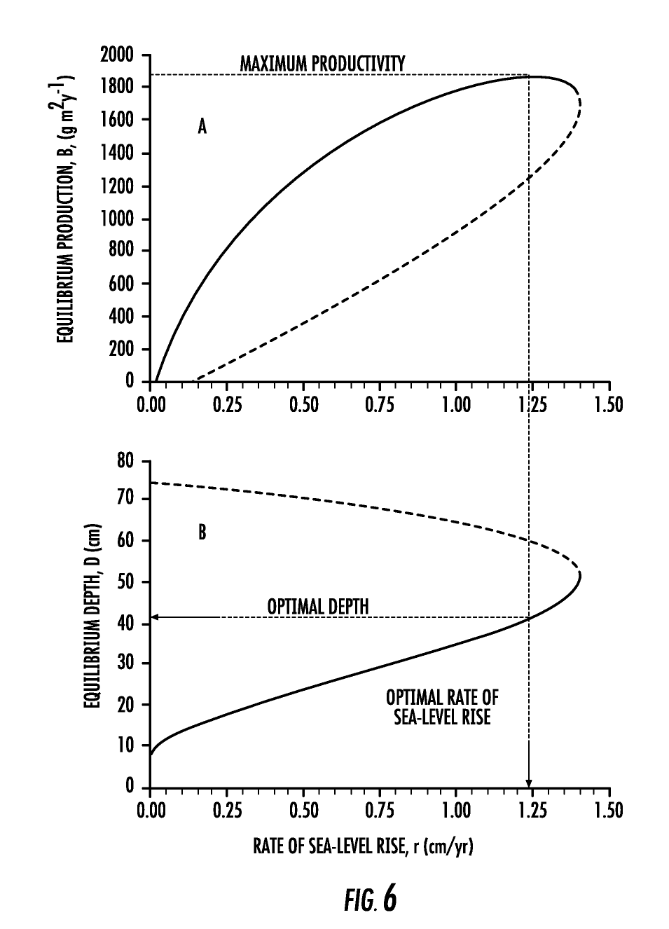

Coastal wetlands (salt marshes) are typically dominated by one dominant species of higher plant. On the east and gulf coasts of the United States the dominant plant is the S. alterniflora species discussed previously, also known as smooth cordgrass. As discussed above, this plant can survive within the intertial zone, and only within the growth range, a limited range of the intertidal zone, approximately between the elevation of mean sea level and mean high water. Within its growth range there is an optimum elevation as shown in FIG. 2 where the productivity of the plant is greatest. Productivity approaches zero near the upper and lower limits of its range. Thus, the distribution of productivity, or biomass density (B), is a function of depth (D) below the elevation of mean high water (MHW). This distribution may be described by the polynomial equation discussed above and further illustrated in FIG. 2 and FIG. 5:

B=aD+bD²+c (Equation 1)

FIG. 5 illustrates the effect of interannual variation in mean sea level and spatial variation in marsh elevation on the relationship of observed productivity of salt marsh macrophytes (S. alterniflora) measured annually since 1984 and the depth below mean high tide (MHT) of marsh sites in South Carolina. As shown in FIG. 5, the biomass (B) of marsh vegetation depends on the depth (D) and depths less than the optimum are stable (—) and depths greater than the optimum (or elevations less than optimal) are unstable (--) against changes in the rate of sea-level rise.

Again, a, b, and c are coefficients that are determined by the upper and lower depth limits, and magnitude of B at the optimum depth. The values of the coefficients a, b, and c will differ regionally as a function of competition from neighboring plant communities, tidal range, salinity, or climate. Productivity is used here as a proxy for biomass density, and its relationship with depth is simplified for analytical purposes, but represents the approximate behavior of B for the depths encountered in real salt marshes.

The net rate of accretion of sediment onto the marsh surface is proportional to the length of time that the marsh surface is flooded by the tides, and the time flooded is proportional to the depth (D) of the marsh surface below MHT. Thus, sedimentation rate is given by the settling rate times the time flooded, or settling rate times depth times a proportionality constant or dY/dt=qD, where q is the settling velocity modified by the proportionality constant and D is depth below mean high tide. It has been determined that the presence of plant biomass on the marsh surface enhances the sedimentation rate. Plants filter particles from the water and create a friction on flowing water that enhances the settlement of particles suspended in water. This effect is proportional to the amount of plant biomass (B) and the depth of the water (D). Thus, the sedimentation rate can be written as:

dY/dt=(q+kB)D (Equation 2)

where k is analogous to a trapping efficiency and q, B and D are as defined above.

B can be substituted in Equation 2 from Equation 1 to obtain the sedimentation rate as a function of one variable, depth D:

dY/dt=[q+k(aD+bD²+c)]D

or

dY/dt=(q+c)D+kaD²+bD³ (Equation 3)

If the elevation of the marsh surface is in equilibrium with the rate of sea-level rise, termed r, then:

dY/dt=r

or

(q+c)D+kaD²+bD³−r=0 (Equation 4)

After substituting values for the constants (q, k, a, b, and c), solutions to equation 4 are obtained by substituting different rates of sea-level rise (r) into equation 4 and solving for D.

With reference to FIG. 6, equilibrium combinations of biomass density (in panel A) and equilibrium depth D below mean high water (panel B) as functions of the rate of relative sea-level rise and computed from Equation 4 with q=0.0018 and k=1.5×10⁻⁵ are illustrated. The optimal depth is the depth below MHT that results in maximum standing biomass. The solid portions of the curves (—) represent equilibrium conditions within a region of stability, where the system is stable against an increased rate of sea-level rise (i.e. ∂r/∂D>0). The dashed line segments represent equilibrium conditions where the system is unstable (i.e. ∂r/∂D<0) against a change in the rate of sea-level rise.

In accordance with the present disclosure, Equation 4 proves that there is a maximum rate of sea-level rise, above which the marsh surface cannot maintain its elevation within the growth range. This limit for the parameters provided is between 1.25 and 1.5 cm/yr. For rates of sea-level rise less than the limit, there are two depths that satisfy equation 4. However, only depths that are less than the optimal depth are stable, because in this region ∂r/∂D>0, that is, an increase in sea-level rise, or r, results in an increase in depth, and this new depth remains within the growth range of S. alterniflora.

Equilibrium depths greater than the optimum depth (--in FIGS. 5 and 6) are unstable. As shown in FIG. 6B, for suboptimal depths i.e. ∂r/∂D<0, that is, an increase in sea-level rise, or r, results in a decrease in depth. Clearly this is not possible. An increase in sea level must increase depth. Theoretically, this range of depths is within the growth range, but if the depth of the marsh surface should increase above the optimum depth, further increases in sea level will further increase depth, decrease biomass and sedimentation, leading ultimately toward complete loss of the vegetation.

The skewness statistic can be computed using software in accordance with the present disclosure from a geographic information system (GIS) layer consisting of LIDAR elevations in which non-wetland habitat is masked. Many different technologies are compatible with the objectives described herein. For instance, existing ground-based monitoring and remote sensing technology can be utilized in connection with the present disclosure. The statistic is related to risk of loss when it is computed on LIDAR data that span the marsh landscape (i.e. a marsh island or a cross section of marsh spanning the ecotone between upland and tidal creek). Alternatively, the statistic can be computed point by point using neighboring points within a fixed radius, resulting in a continuous skewness map. When the spatial distribution of the skewness statistic is plotted by converting the number to a grey scale, the areas at greatest risk will be revealed.

Knowledge of the spatial distribution of the risk determined in accordance with the present disclosure informs property owners, zoning boards, and the insurance industry about the hazards associated with coastal development, and resource managers about the stability of habitats that are important for biological resources. Property adjacent to wetlands at high risk of loss will bear a higher risk of destruction from storm surge and erosion. The decision to develop and where to develop can be dependent on the risk statistic described herein. Further, set back requirements required by ordinances can be made to depend on the statistic described herein.

The present disclosure can be better understood with reference to the following examples.

### EXAMPLES

The skewness statistic is a measure of the degree of asymmetry of a distribution around its mean. Positive skewness indicates a distribution with an asymmetric tail extending towards more positive values. Negative skewness indicates a distribution with an asymmetric tail extending towards more negative values. A variable with a normal (bell shaped) distribution has a skewness of zero. The skewness statistic is calculated using the following formula:

$$skewness = \frac{{\sum }_{i - 1}^{N} {( {Y}_{i} - \overline{Y} )}^{3}}{( N - 1 ) {s}^{3}}$$

where N is equal to the number of samples, Yᵢ are the values of the set of N elevations, Y̅ is the mean of all elevations, and s is the standard deviation. This statistic will be negative if the surface of the wetland is located near the highest position in the tidal frame. This will signify a stable wetland. The skewness will be positive if the wetland surface is crowded near the lower range of the vegetation. Positive skewness indicates a wetland that is unstable and threatened by erosion and sea-level rise.

In the interests of brevity and conciseness, any ranges of values set forth in this specification are to be construed as written description support for claims reciting any sub-ranges having endpoints which are whole number values within the specified range in question. By way of a hypothetical illustrative example, a disclosure in this specification of a range of 1-5 shall be considered to support claims to any of the following sub-ranges: 1-4; 1-3; 1-2; 2-5; 2-4; 2-3; 3-5; 3-4; and 4-5.

These and other modifications and variations to the present disclosure can be practiced by those of ordinary skill in the art, without departing from the spirit and scope of the present disclosure, which is more particularly set forth in the appended claims. In addition, it should be understood that aspects of the various embodiments can be interchanged both in whole or in part. Furthermore, those of ordinary skill in the art will appreciate that the foregoing description is by way of example only, and is not intended to limit the disclosure so further described in such appended claims.

1. A system for determining risk of loss to a wetland habitat comprising:
a computer, the computer configured to receive light detection and ranging data about a wetland habitat elevation and calculate the frequency distribution of the wetland habitat elevation based on the light detection and ranging data;
the computer further configured to calculate a skewness statistic based on the frequency distribution of the wetland habitat elevation, the skewness statistic being negative, zero, or positive; and
the computer configured to calculate risk of loss to the wetland habitat by utilizing the skewness statistic.

2. The system of claim 1, wherein the skewness statistic is calculated using the following formula:
$$skewness = \frac{{\sum }_{i - 1}^{N} {( {Y}_{i} - \overline{Y} )}^{3}}{( N - 1 ) {s}^{3}}$$
where N is equal to the number of samples of the wetland habitat elevation, Yᵢ are the values of the set of N elevations, Y̅ is the mean of all elevations, and s is the standard deviation.

3. The system of claim 1, wherein a negative skewness statistic indicates a lower risk of loss than a positive skewness statistic.

4. The system of claim 1, wherein the risk of loss is presented graphically.

5. The system of claim 1, wherein the risk of loss is presented through the Internet.

6. The system of claim 1, wherein a positive skewness statistic indicates an unstable wetland habitat.

7. The system of claim 1, wherein a negative skewness statistic indicates a stable wetland habitat.

8. The system of claim 1, wherein the computer receives light detection and ranging data about a wetland habitat elevation through the Internet.

9. The system of claim 1, wherein the computer is connected to a printer configured to stores print the risk of loss to the wetland habitat.

10. A system for determining risk of loss to a wetland habitat comprising:
a computer, the computer configured to receive light detection and ranging data about a wetland habitat elevation and calculate the frequency distribution of the wetland habitat elevation based on the light detection and ranging data;
the computer configured to calculate a skewness statistic based on the frequency distribution of the wetland habitat elevation, wherein the skewness statistic is calculated using the following formula:
$$skewness = \frac{{\sum }_{i - 1}^{N} {( {Y}_{i} - \overline{Y} )}^{3}}{( N - 1 ) {s}^{3}}$$
where N is equal to the number of samples of the wetland habitat elevation, Yᵢ are the values of the set of N elevations, Y̅ is the mean of all elevations, and s is the standard deviation, the skewness statistic being negative, zero, or positive; and
the computer configured to calculate risk of loss to the wetland habitat by utilizing the skewness statistic.

11. The system of claim 1, wherein the computer is capable of displaying the risk of loss to the wetland habitat.

12. The system of claim 11, wherein the computer is configured to present a map of the wetland habitat.

13. The system of claim 10, wherein a negative skewness statistic indicates a lower risk of loss than a positive skewness statistic.

14. The system of claim 10, wherein the risk of loss is presented graphically.

15. The system of claim 10, wherein the risk of loss is presented through the Internet.

16. The system of claim 10, wherein a positive skewness statistic indicates an unstable wetland habitat.

17. The system of claim 10, wherein a negative skewness statistic indicates a stable wetland habitat.

18. A method for determining risk of loss to a wetland habitat comprising:
calculating a risk of loss to a wetland habitat by utilizing a computer and light detection and ranging data about a wetland habitat elevation, the computer configured to receive the light detection and ranging data and calculate the frequency distribution of the wetland habitat elevation based on the light detection and ranging data, the computer further configured to calculate a skewness statistic based on the frequency distribution of the wetland habitat elevation, the skewness statistic being negative, zero, or positive, and the computer configured to calculate risk of loss to the wetland habitat by utilizing the skewness statistic.

19. The method of claim 18, wherein the skewness statistic is calculated using the following formula:
$$skewness = \frac{{\sum }_{i - 1}^{N} {( {Y}_{i} - \overline{Y} )}^{3}}{( N - 1 ) {s}^{3}}$$
where N is equal to the number of samples of the wetland habitat elevation, Yᵢ are the values of the set of N elevations, Y̅ is the mean of all elevations, and s is the standard deviation.

20. The method of claim 18, wherein a negative skewness statistic indicates a lower risk of loss than a positive skewness statistic.
